(19) United States
(12) Patent Application Publication
(10) Pub. No.: US 2011/0255897 A1
(43) Pub. Date: Oct. 20, 2011

(54) DEVELOPING DEVICE

(75) Inventor: Kensuke Sato, Saitama-shi (JP)

(73) Assignee: CANON KABUSHIKI KAISHA, Tokyo (JP)

(21) Appl. No.: 13/088,577

(22) Filed: Apr. 18, 2011

(30) Foreign Application Priority Data
Apr. 20, 2010 (JP) 2010-097113

(51) Int. Cl. G03G 15/08

(52) U.S. Cl. 399/103; 399/104

(57) ABSTRACT

A developing device includes a developer carrying member for carrying a magnetic developer to form a developer image on an image bearing member; a developing device frame including a first accommodating chamber for accommodating the magnetic developer and including a second accommodating chamber, in which the developer carrying member is provided, for accommodating the magnetic developer supplied from the first accommodating chamber through a first opening; a removable sealing member for sealing the first opening; and a magnetic seal, provided between a longitudinal end portion of the developer carrying member and the developing device frame. The sealing member is removable through a second opening which is defined at least partly by the magnetic seal.

### FIELD OF THE INVENTION AND RELATED ART

The present invention relates to a developing device for developing an electrostatic latent image formed on an electrophotographic photosensitive member.

In an image forming apparatus for forming an image on a latent image bearing member by using an electrophotographic process, a process cartridge type has been conventionally employed. In the process cartridge type, the electrophotographic photosensitive member and process means acting on the electrophotographic photosensitive member are integrally assembled into a cartridge, and the cartridge is configured to be detachably mountable to a main assembly of the image forming apparatus. According to this process cartridge type, a user can perform a maintenance of the apparatus by himself (herself) without relying on a service person, so that operativity can be remarkably improved. For that reason, this process cartridge type has been widely used in the image forming apparatus.

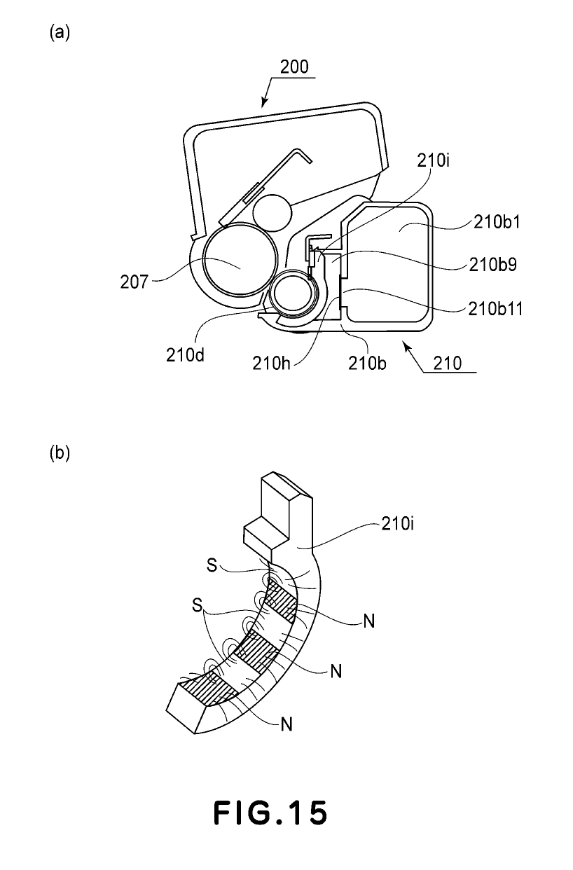

A schematic structure of a developing device 210 incorporated into a process cartridge 200 is shown in (a) of FIG. 15. A method in which a seal member of a magnetic material (hereinafter referred to as a magnetic seal) 210i is provided at both end portions, with a predetermined spacing, of a rotatably provided developing sleeve 210d to prevent toner from flowing into an area other than a developing area in the developing device 210 as shown in (a) of FIG. 15 has been proposed. The magnetic seal 210i is magnetized in a magnetic pole pattern as shown in (b) of FIG. 15. Thus, a gap between an outer peripheral surface of the developing sleeve 210d and a surface of the magnetic seal 210i is filled by a magnetic brush of a chain of the toner formed along magnetic lines of force, so that the toner is prevented from flowing into the area other than the developing area. The magnetic seal 210i is also magnetized at a surface on a developing device frame 210b side, so that the toner is prevented from flowing into an area other than the developing area from a gap between the magnetic seal 210i and the developing device 210 which fixes the magnetic seal 210i.

Such a developing device frame 210b of the developing device 210 includes a developing portion 210b9 where the developing sleeve 210d for supplying the toner to the electrostatic latent image formed on an electrophotographic photosensitive member (hereinafter referred to as a photosensitive drum) 207 is disposed, and includes a toner accommodating portion 210b1 for accommodating the toner. Here, in the process cartridge 200, a toner seal member (sealing member) 210h for sealing the toner accommodating portion 210b1 is provided.

When the toner is discharged from the toner accommodating portion 210b1 to the developing sleeve 210d at the time of start of use of the process cartridge 200, first, an operation for pulling out and removing the toner seal member 210h from the outside of the process cartridge 200 to unseal the toner accommodating portion 210d. As a result, the toner accommodated in the toner accommodating portion 210b1 is discharged and supplied toward the developing sleeve 210d side through an unsealed (uncovered) developing opening 210b11. For this reason, as the toner seal member 210h, a member, which is generally called a toner seal film, for sealing the developing opening 210b11 of the toner accommodating portion 210b1 is used.

Here, Japanese Laid-Open Patent Application (JP-A) Hei 9-26743 discloses a constitution in which a slit for permitting pulling-out of the toner seal member from the outside of the developing device (hereinafter referred to as a toner seal opening) is provided in the developing device frame, and the toner seal member is inserted through the toner seal opening to expose an end portion thereof to the outside of the developing device. In this constitution, after the toner seal member is inserted, the toner seal opening is blocked with a cap member which is an elastic member for preventing toner leakage.

JP-A 2000-75620 discloses a constitution in which a toner accommodating portion frame and a developing portion frame are prepared as separate members and an end portion of a toner seal member is exposed to the outside of the developing device by sandwiching the toner seal member at a toner seal opening formed when the toner accommodating portion frame and the developing device frame are connected. In this constitution, at a portion, contacted to the toner seal member, of one of the toner accommodating portion frame and the developing device frame, a raising end portion seal member is disposed.

However, in the above-described constitution, a part for confining the toner, such as a cap member is required. Further, in the constitution, the toner seal opening 210 is hermetically sealed with the cap member or the end portion seal member and therefore a force for pulling out the toner seal member 210h becomes large, so that there is a possibility that usability is impaired.

### SUMMARY OF THE INVENTION

A principal object of the present invention is to provide a developing device capable of easily assembling an opening for permitting pulling-out of a toner seal member for sealing a toner accommodating chamber to an outside thereof without increasing the number of parts while suppressing a pulling-out force of the toner seal member without loss of a toner sealing function.

According to an aspect of the present invention, there is provided a developing device comprising:

a developer carrying member for carrying a magnetic developer to form a developer image on an image bearing member;

a developing device frame including a first accommodating chamber for accommodating the magnetic developer and including a second accommodating chamber, in which the developer carrying member is provided, for accommodating the magnetic developer supplied from the first accommodating chamber through a first opening;

a removable sealing member for sealing the first opening; and

a magnetic seal, provided between a longitudinal end portion of the developer carrying member and the developing device frame, wherein the sealing member is removable through a second opening which is defined at least partly by the magnetic seal.

According to another aspect of the present invention, there is provided a developing device comprising:

a developer carrying member for carrying a magnetic developer to form a developer image on an image bearing member;

a developing device frame including a first accommodating chamber for accommodating the magnetic developer and including a second accommodating chamber, in which the developer carrying member is provided, for accommodating the magnetic developer supplied from the first accommodating chamber through a first opening;

a removable sealing member for sealing the first opening, wherein the sealing member is removable through a second opening; and

a magnetic seal, provided between a longitudinal end portion of the developer carrying member and the developing device frame, for preventing the magnetic developer from moving to an outside of the developing device through the second opening.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

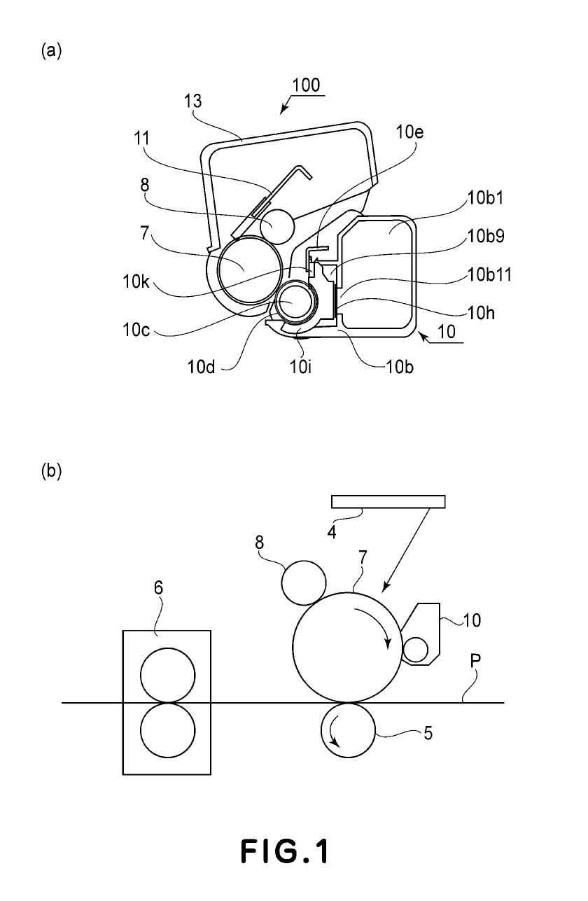

Parts (a) and (b) of FIG. 1 are schematic views showing a structure of a process cartridge in Embodiment 1.

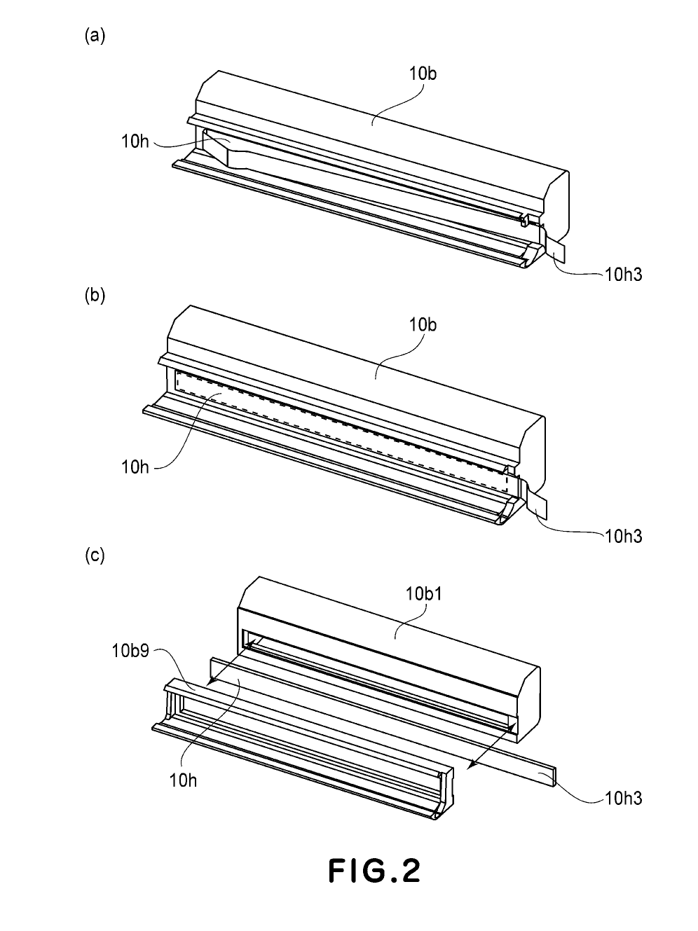

Parts (a), (b) and (c) of FIG. 2 are schematic views for illustrating a toner seal member.

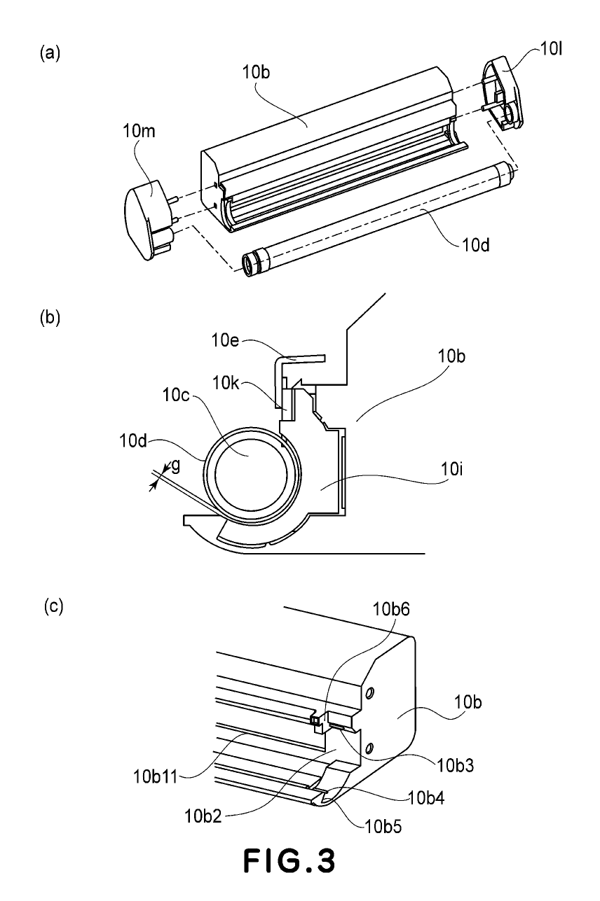

Parts (a), (b) and (c) of FIG. 3 are schematic views for illustrating a developing device frame and a developing sleeve in Embodiment 1.

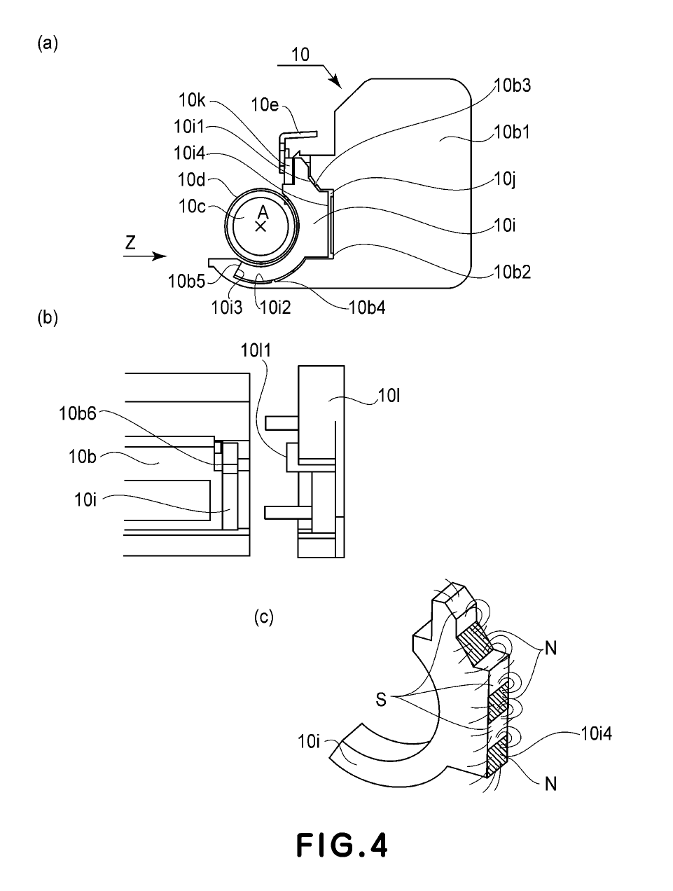

Parts (a), (b) and (c) of FIG. 4 are schematic views showing a structure of a developing device in Embodiment 1.

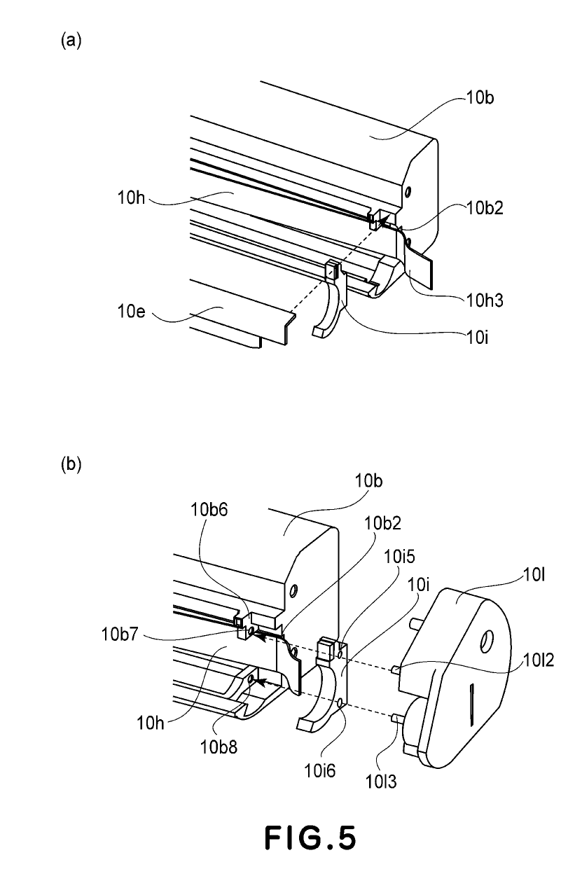

Parts (a) and (b) of FIG. 5 are schematic views for illustrating a mounting method of the toner seal member in Embodiment 1.

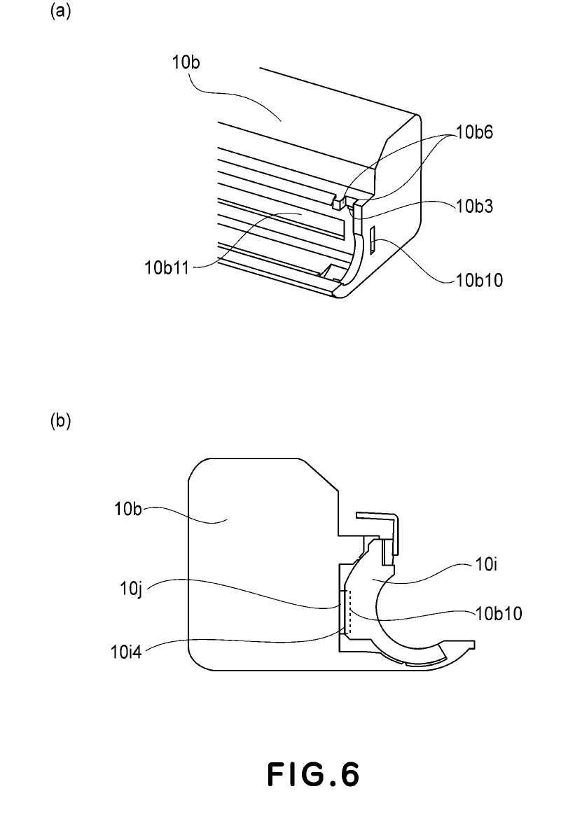

Parts (a) and (b) of FIG. 6 are schematic views showing principal portions of a process cartridge in Embodiment 2.

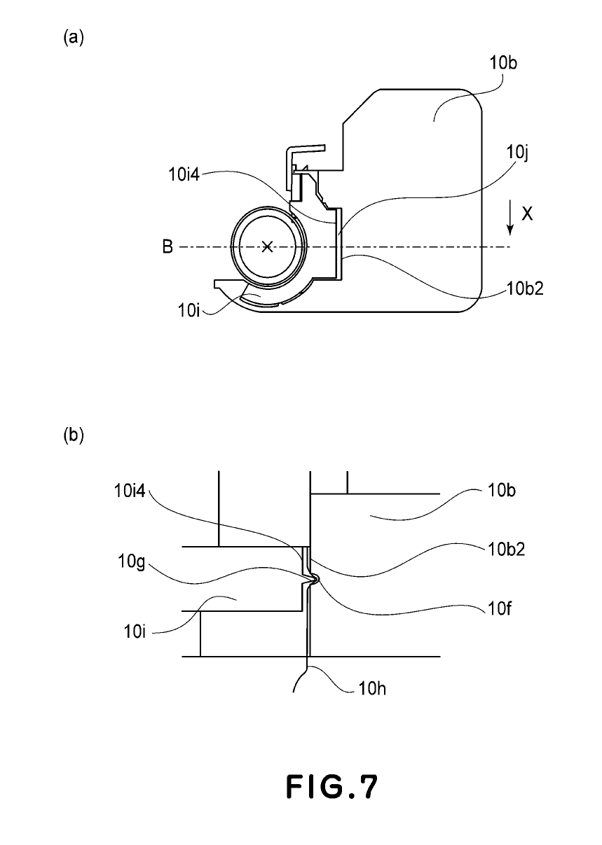

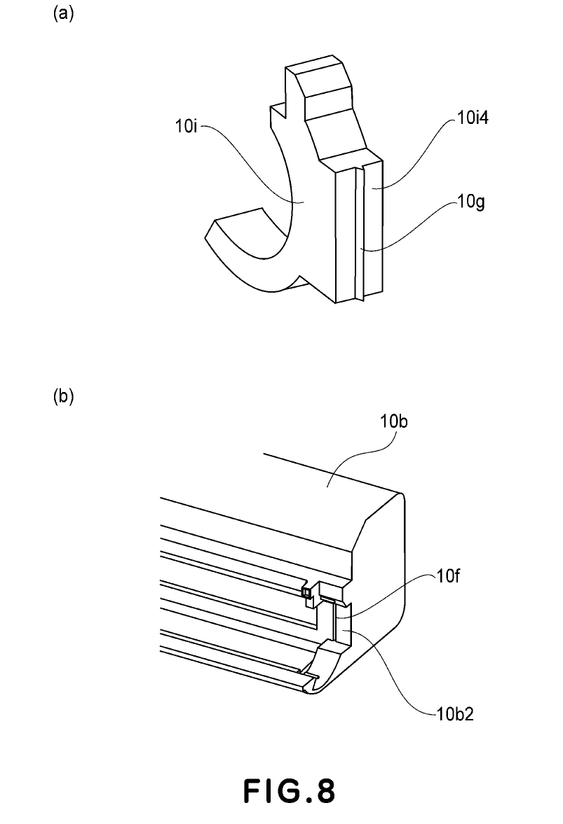

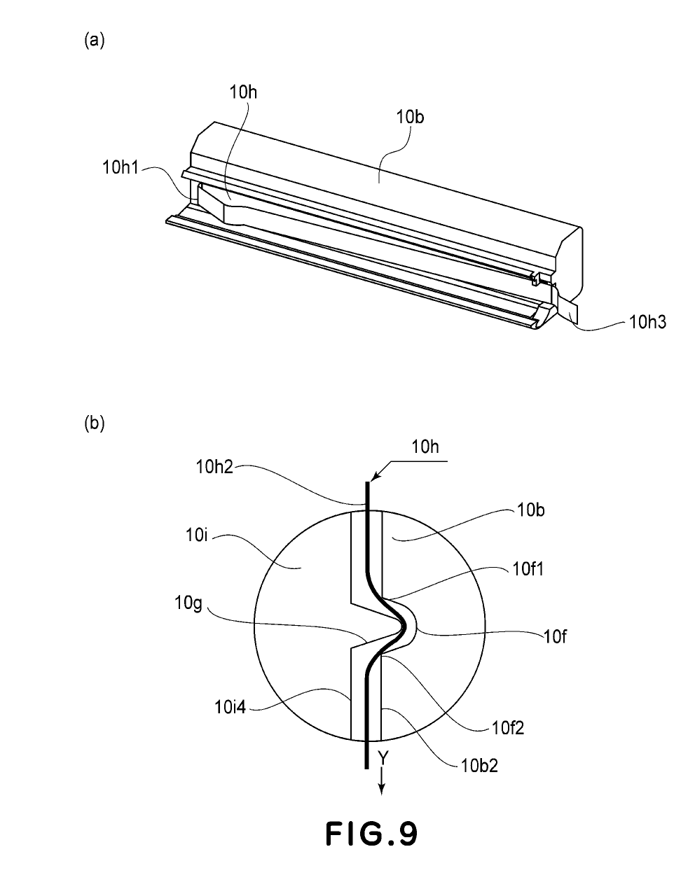

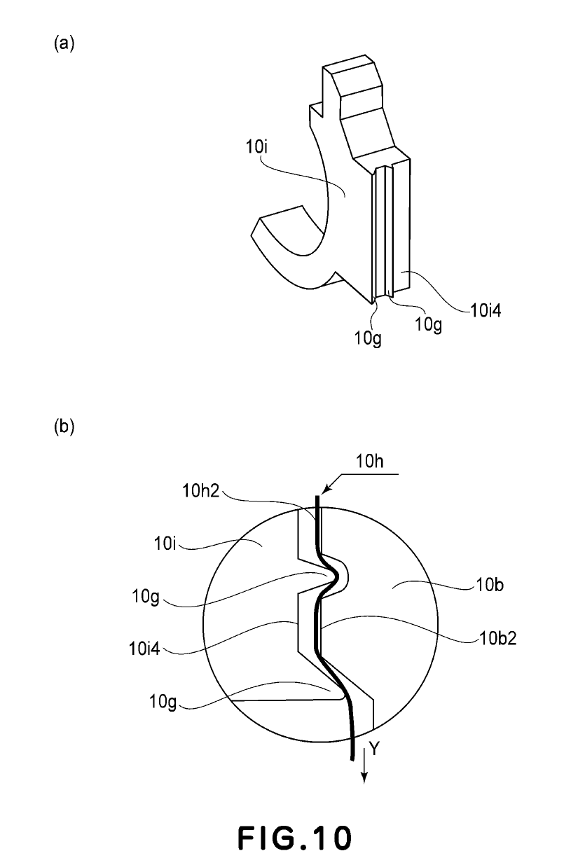

Parts (a) and (b) of FIG. 7, (a) and (b) of FIG. 8, (a) and (b) of FIG. 9 and (a) and (b) of FIG. 10 are schematic views showing principal portions of a process cartridge in Embodiment 3.

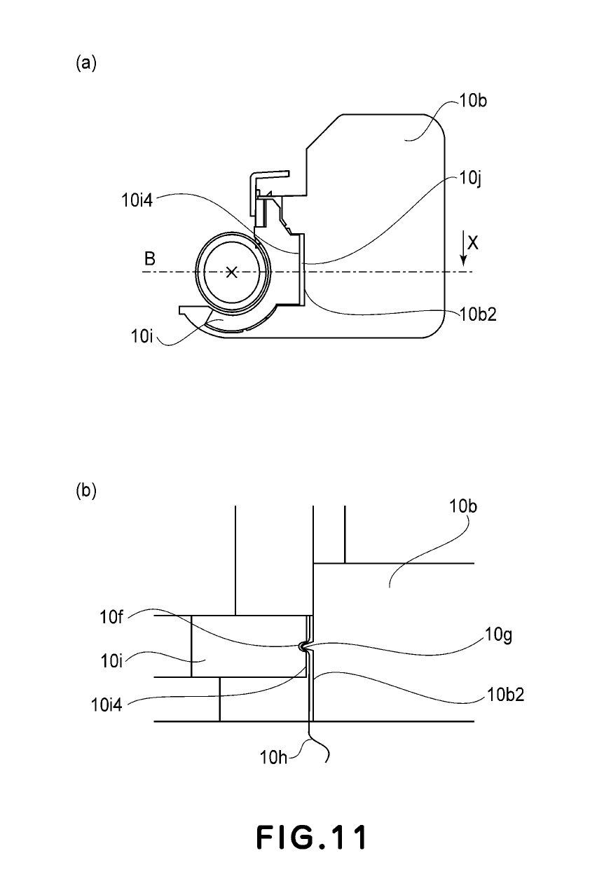

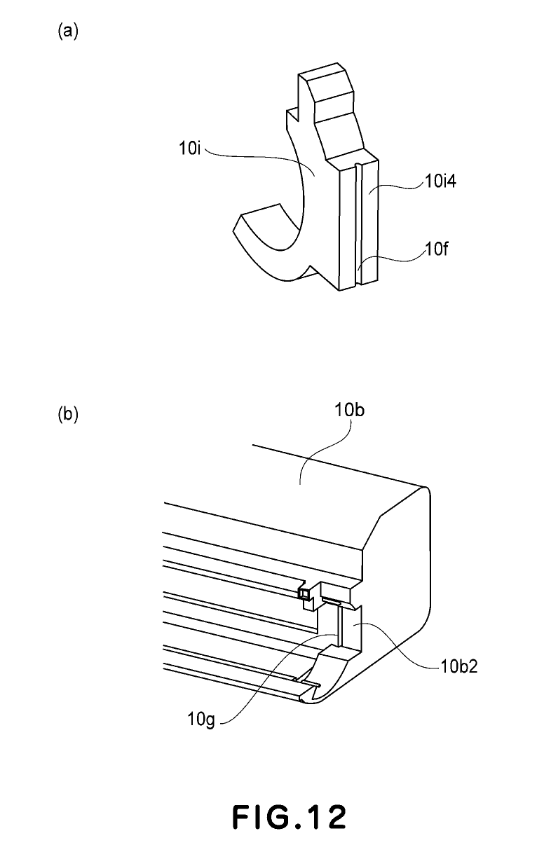

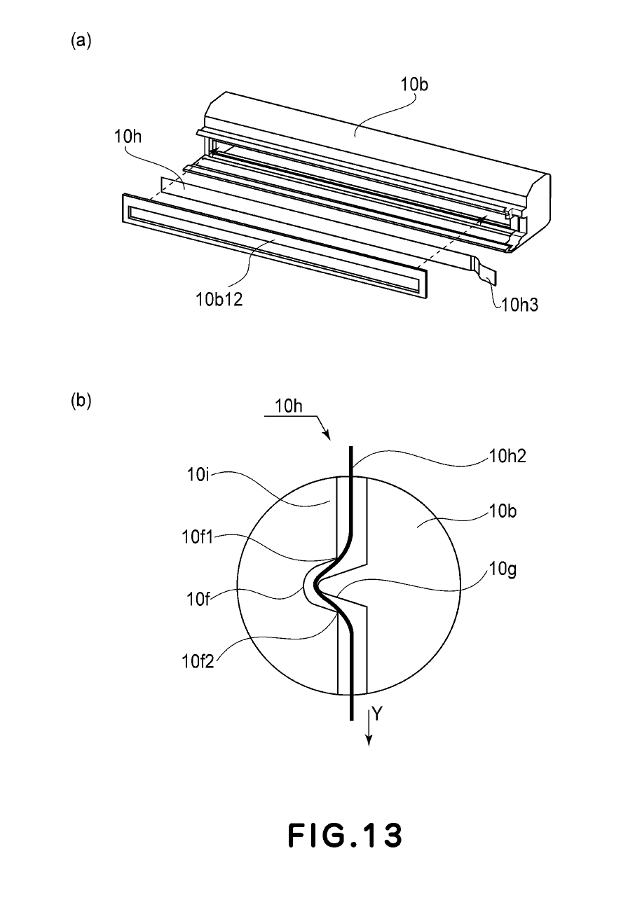

Parts (a) and (b) of FIG. 11, (a) and (b) of FIG. 12 and (a) and (b) of FIG. 13 are schematic views showing principal portions of a process cartridge in Embodiment 4.

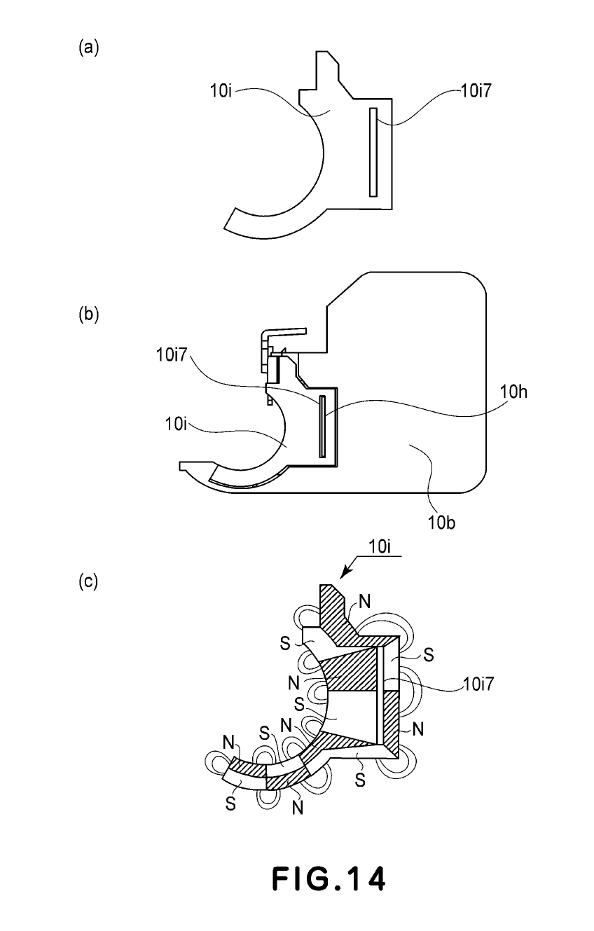

Parts (a), (b) and (c) of FIG. 14 are schematic views showing principal portions of a process cartridge in Embodiment 5.

Parts (a) and (b) of FIG. 15 are schematic views showing a conventional process cartridge.

### DESCRIPTION OF THE PREFERRED EMBODIMENTS

Hereinbelow, embodiments for carrying out the present invention will be exemplarily and specifically described with reference to the drawings. However, dimensions, materials, shapes, relative arrangements and the like of constituent elements described in the following embodiments are appropriately changed depending on constitutions or various conditions of devices (apparatuses) to which the present invention is applied and thus the scope of the present invention is not limited thereto.

In the following embodiments, as a developer, magnetic toner (hereinafter simply referred to as toner) is used. Further, sectional views and sectional shapes in the embodiments are based on a cross section with respect to a direction perpendicular to a rotational axis of a developing sleeve 10d as a developer carrying member for carrying the toner for use in development of an electrostatic latent image formed on an electrophotographic photosensitive member. Further, the rotational axis direction of the developing sleeve 10d is longitudinal direction.

### Embodiment 1

Part (a) of FIG. 1 is a sectional view showing a schematic structure of a process cartridge in this embodiment, and (b) of FIG. 1 is a schematic structural view for illustrating an image forming operation of an image forming apparatus in this embodiment. First, with reference to (b) of FIG. 1, the image forming operation of the image forming apparatus will be described. On a surface of a drum-like latent image bearing member (hereinafter referred to as a photosensitive drum) 7 as an electrophotographic photosensitive member uniformly charged by a charging device 8, an electrostatic latent image is formed by irradiation with laser light emitted from a scanner unit 4 correspondingly to image information. Then, this electrostatic latent image is developed into a toner image by a developing device (developing means) 10 and thereafter is transferred onto a recording material P by a transfer device 5. Then, the toner image on the recording material P is heated by a heating device 6 to be fixed on the recording material, so that an image is formed on the recording material P.

Next, with reference to (a) of FIG. 1, the process cartridge in this embodiment will be described. In this embodiment, a process cartridge 100 includes the photosensitive drum 7 and at least one process means. Here, examples of the process means include the charging device 8 for electrically charging the surface of the photosensitive drum 7, the developing device 10 for forming the toner image on the photosensitive drum 7, a cleaning means 11 for removing the toner remaining on the photosensitive drum 7, and the like. The process cartridge 100 is prepared by disposing the charging device 8 and the cleaning means 11 at a periphery of the photosensitive drum 7, and these means are covered with a housing constituted by a cleaning frame 13, a developing device frame 10b and the like, thus being assembled into a cartridge.

The developing device 10 contained in the process cartridge 100 is constituted by a toner accommodating portion 10b1 and the developing device frame 10b including a developing portion 10b9. Here, the toner accommodating portion 10b1 corresponds to a first accommodating chamber for accommodating the toner, and the developing position 10b9 corresponds to a second accommodating chamber for accommodating the toner to be carried on the developing sleeve 10d and for being supplied with the toner from the toner accommodating portion 10b1 (the first accommodating chamber).

The developing device frame 10b of the developing device 10 is rotatably provided with the developing sleeve 10d for carrying and feeding the toner in the developing portion 10b9 (the toner accommodating portion 10b1) to the photosensitive drum 7.

The toner accommodating portion 10b1 is provided with a developing opening as a first opening for permitting feeding of the toner to the developing sleeve 10d and a toner seal member 10h for sealing (covering) the developing opening 10b11.

Parts (a), (b) and (c) of FIG. 2 are schematic views for illustrating the toner seal member 10h. The toner seal member 10h is disposed to cover the developing opening when the developing device 10 is not yet used, thus confirming the magnetic toner in the toner accommodating portion 10b1. Then, at the time of use, an end portion 10h3 of the toner seal member 10h is pulled out and thus the toner seal member 10h is pulled out to the outside of the developing device 10, so that the developing opening 10b11 can be uncovered.

Specifically, as shown in (a) of FIG. 2, there is a constitution in which the toner seal member 10h constituted by a film or the like is separably applied onto the developing opening 10b11 so that it is folded back at a side opposite from the pulling-out side. In this constitution, the toner seal member 10h is removed by pulling out the end portion 10h3 at the pulling-out side of the toner seal member 10h.

Further, as shown in (b) of FIG. 2, there is also a constitution in which the toner seal member 10 constituted by a film or the like is separably applied onto the developing opening 10b11 and is not folded on the side opposite from the pulling-out side, different from the constitution of (a) of FIG. 2. Also in this constitution, the toner seal member 10h is removed by pulling out the end portion 10h3 at the pulling-out side of the toner seal member 10h.

Further, as shown in (c) of FIG. 2, there is also a constitution in which the toner seal member 10h is held in a pullable state by being sandwiched between the developing portion 10b9 and the toner accommodating portion 10b1 and is removed by pulling out the end portion 10h3 of the toner seal member 10h.

Part (a) of FIG. 3 is a schematic view for illustrating the developing device frame 10b and the developing sleeve 10d. The developing sleeve 10d contains a magnet member 10c and is rotatably supported by a non-driving side holder member 10l and a driving side holder member 10m which are supported by longitudinal end portions of the developing device frame 10b. The toner supplied from the toner accommodating portion 10b1 is deposited on the surface of the surface of the developing sleeve 10d by a magnetic force of the magnet member 10c. Then, the toner on the developing sleeve 10d is regulated to have a constant layer thickness and thereafter is deposited on the latent image on the photosensitive drum 7 at a position, in which the developing sleeve 10d opposes the photosensitive drum 7, by rotation of the developing sleeve 10d.

Part (b) of FIG. 3 is a partial sectional view of the developing device 10. At end portions of the developing sleeve 10d with respect to the longitudinal direction, a pair of seal members of a magnetic material, i.e., magnetic seals 10i with a predetermined spacing (gap) between the outer peripheral surface of the developing sleeve 10d and themselves are provided. The magnetic seal 10i generates a magnetic force for carrying the toner in the gap between the outer peripheral surface of the developing sleeve 10d and the magnetic seal 10i. By providing the magnetic seal 10i, the gap between the outer peripheral surface of the developing sleeve 10d and the surface of the magnetic seal 10i is blocked by a magnetic brush of a chain of the toner formed by magnetic force of lines, so that the toner is prevented from flowing into an area out of a developing area.

The magnetic seals 10i are, as shown in (b) of FIG. 3, provided at end portions of the developing sleeve 10d so as to be disposed with a predetermined gap g with respect to the outer peripheral surface of the developing sleeve 10d, and are attached to the developing sleeve 10d and the developing device frame 10d in this state.

Part (c) of FIG. 3 is a partial perspective view of the developing device frame 10b. The developing device frame 10b includes a first position projection 10b3 and a second positioning projection 10b4 which are configured to position the magnetic seal 10i, a rotation stopping surface 10b5 for stopping the rotation of the magnetic seal 10i, and an opening forming portion 10b2 which is a part of a toner seal opening 10j. Here, the toner seal opening 10j is a second opening through which the toner seal member 10h to be pulled out at the time of start of use passes and through which a part (the end portion 10h3) of the toner seal member 10h is pulled out (exposed) to the outside of the developing device 10 when the developing device 10 is not yet used.

Further, at a base portion of the developing device frame 10b at a side of the developing opening 10b11 with respect to the longitudinal direction of the first positioning projection 10b3, a longitudinal positioning surface 10b6 for positioning the magnetic seal 10i with respect to the longitudinal direction is provided.

Part (a) of FIG. 4 is a sectional view showing a schematic structure of the developing device 10. The magnetic seal 10i includes a leakage preventing surface 10i4 as a part of the toner seal opening 10j, a first positioning surface 10i1 and a second positioning surface 10i2 which are configured to position the magnetic seal 10i relative to the developing device frame 10b, and a rotation stopping surface 10i3 at which the rotation of the magnetic seal 10i is to be stopped. Each of the first positioning surface 10i1 and the second positioning surface 10i2 has an arcuate shape with a rotation center A of the developing sleeve 10d as its center.

The magnetic seal 10i is positioned by contact of the first positioning surface 10i1 and the second positioning surface 10i2 thereof with the first positioning projection 10b3 and the second positioning projection 10b4 of the developing device frame 10b, respectively, and then a developing blade 10e is assembled with the magnetic seal 10i. As a result, a push pad 10k provided between the developing blade 10e and the magnetic seal 10i is compressed, and the magnetic seal 10i is rotated about the rotation center A of the developing sleeve 10d by a repelling force of the push pad 10k generated at that time. Thus, the rotation stopping surface 10i3 abuts against the rotation stopping surface 10b5, so that an attitude of the magnetic seal 10i is determined.

Part (b) of FIG. 4 is a schematic view of the developing device 10 as seen from Z direction of (a) of FIG. 4. The magnetic seal 10i is positioned with respect to the longitudinal direction by abutment thereof against the longitudinal positioning surface 10b6, and a retaining surface 10l1 of the non-driving side holder member 10l constitutes a retaining portion for the magnetic seal 10i and thus is fixed. The developing sleeve 10d is, as shown in (a) of FIG. 3, rotatably supported by the non-driving side holder member 10l and the driving side holder member 10m. As a result, (an inner peripheral surface of) the toner seal opening 10j is defined (constituted) by the leakage preventing surface 10i4 as a part of the magnetic seal 10i and the opening forming portion 10b2 as a part of the developing device frame 10b.

Part (c) of FIG. 4 is a schematic view showing a magnetic pole pattern of the leakage preventing surface 10i4 of the magnetic seal 10i.

In this embodiment, movement of the toner through the toner seal opening 10j toward the outside of the developing device 10 is suppressed by carrying the toner by the magnetic force generated by the magnetic seal 10i. That is, by the magnetic brush of the chain of the toner formed by magnetic force of lines at the leakage preventing surface 10i4, the gap (the toner seal opening 10j) between the leakage preventing surface 10i4 and the opening forming portion 10b2 is blocked so that the toner leakage to the outside of the developing device 10 is prevented.

By constituting the toner seal opening 10j as described above, even when there is no sealing member such as the cap member or the end portion seal member which are configured to confine the toner, it becomes possible to prevent the toner leakage to the outside of the developing device 10 by the magnetic force of the magnetic seal 10i at the leakage preventing surface 10i4. Thus, the toner leakage to the outside of the developing device 10 can be prevented by the magnetic force of the magnetic seal 10i at the leakage preventing surface 10i4, so that a force required when the toner seal member 10h is pulled out can be reduced and therefore usability (convenience) can be improved.

Part (a) of FIG. 5 is a schematic view for illustrating a mounting method of the toner seal member 10h in the developing device 10. As shown in (a) of FIG. 5, in the above constitution, an assembling method in which the end portion 10h3 of the toner seal member 10h is disposed at the opening forming portion 10b2 of the developing device frame 10b and thereafter the magnetic seal 10i is mounted can be employed. As a result, the assembling can be easily performed by only placing the toner seal member 10h on the opening forming portion 10b2 of the developing device frame 10b at the toner seal opening 10j.

Part (b) of FIG. 5 is an exploded perspective view of the developing device 10, in which a positioning constitution of the magnetic seal 10i capable of obtaining the same effect as that of the constitution described above. Incidentally, for the sake of explanatory convenience, the developing device 10d is omitted.

In this constitution, a positioning boss 10l2 and a rotation stopping boss 10l3 which are provided on the non-driving holder member 10l are engaged into a positioning hole 10i5 and a rotation stopping hole 10i6, respectively, which are provided in the magnetic seal 10i. Further, the positioning boss 10l2 and the rotation stopping boss 10l3 are engaged into a first frame hole 10b7 and a second frame hole 10b8, respectively, which are provided in the developing device frame 10b. As a result, the non-driving side holder member 10l and the magnetic seal 10i are positioned and fixed to the developing device frame 10b. Even in such an assembling constitution of the magnetic seal 10i, it becomes possible to easily assemble the toner seal member 10h similarly as in the assembling method described above.

### Embodiment 2

In this embodiment, constituents or portions similar to those in Embodiment 1 are represented by the same reference numerals or symbols, thus being omitted from the description.

Part (a) of FIG. 6 is a partial perspective view of the developing device frame 10b in this embodiment. The toner accommodating portion 10b1 and the developing portion 10b9 are constituted as an integral developing device frame 10b. The developing device frame 10b includes a frame opening 10b10 through which the toner seal member 10h is to be passed when the toner seal member 10h is exposed to the outside of the developing device 10.

The developing device frame 10b includes a longitudinal positioning surface 10b6 in the neighborhood of the first positioning projection 10b3. The longitudinal direction of the magnetic seal 10i is positioned by engaging the magnetic seal 10i with the longitudinal position surface 10b6 with respect to a width thereof.

Part (b) of FIG. 6 is a schematic view showing a structure in the case where a cross section of the developing device 10 including the developing opening 10b11 is illustrated so as to show the magnetic seal 10i. The magnetic seal 10i includes the leakage preventing surface 10i4 and is fixed to the developing device frame 10b so as to cover a part of the frame opening 10b10 at the leakage preventing surface 10i4.

In this embodiment, a gap formed between the leakage preventing surface 10i4 of the magnetic seal 10i and the part of the frame opening 10b10 constitutes the toner seal opening 10j through which the toner seal member 10h is to be passed and through which the end portion 10h3 of the toner seal member 10h is to be exposed to the outside of the developing device 10.

By constituting the toner seal opening 10j as described above, also in this embodiment, it is possible to achieve the same effect as that in Embodiment 1.

### Embodiment 3

In this embodiment, constituents or portions similar to those in Embodiment 1 are represented by the same reference numerals or symbols, thus being omitted from the description.

Part (a) of FIG. 7 is a sectional view showing a structure of the developing device 10 in this embodiment, and (b) of FIG. 7 is a schematic view of a cross section of the developing device 10 taken along a chain line B indicated in (a) of FIG. 7 and as seen from a direction indicated by an arrow X in (a) of FIG. 7.

At the leakage preventing surface 10i4 of the magnetic seal 10i, a wiping projection 10g as a projection projected in a direction of the opening forming portion 10b2 of the developing device frame 10b is provided. At the opening forming portion 10b2 of the developing device frame 10b, a wiping recess portion 10f where the wiping projection 10g enters is provided. The wiping recess portion 10f is configured so that it is not contacted to the wiping projection 10g and is spaced from the leakage preventing surface 10i4 by a predetermined distance.

Part (a) of FIG. 8 is a schematic perspective view of the magnetic seal 10i in this embodiment. The wiping projection 10g is extended over the entire leakage developing sleeve 10i4 with respect to a direction perpendicular to the pulling-out direction of the toner seal member 10h. Part (b) of FIG. 8 is a schematic perspective view of the developing device frame 10b. The wiping recess portion 10f is extended over the entire opening forming portion 10b2 with respect to the direction perpendicular to the pulling-out direction of the toner seal member 10h.

Part (a) of FIG. 9 is a schematic perspective view of the developing device frame 10b. The toner seal member 10h is a film-like elongated sheet member and includes a folding-back portion (intermediate portion) 10h1 where the toner seal member 10h is folded back at an end portion opposite from the side on which the toner seal opening 10j is formed.

When the developing device 10 is not yet used, one end and the other end of the elongated toner seal member 10h are disposed at the side where the toner seal opening 10j for the toner seal member 10h is provided. The one end of the toner seal member 10h is disposed at an end portion of the developing opening 10b11 at the side where the toner seal opening 10j is disposed with respect to the longitudinal direction of the developing opening 10b11. Further, at an opposite end portion from the end portion of the developing opening 10b11 at the side where the toner seal opening 10j is disposed with respect to the longitudinal direction of the developing opening 10b11, the folding-back portion 10h1 is disposed. In this embodiment, the developing opening 10b11 is covered by applying thereto the toner seal member 10h from the one end of the toner seal member 10h to the folding-back portion 10h1. The end portion 10h3 which is the other end, with respect to the longitudinal direction, of the toner seal member 10h is folded back at the folding-back portion 10h1 and then is pulled out through the toner seal opening 10j to the outside of the developing device 10, thus being exposed.

Part (b) of FIG. 9 is a schematic view showing a state in which the toner seal member 10h shown in (b) of FIG. 7 is pulled out in a pulling-out direction indicated by an arrow Y.

A developing opening surface 10h2 which is a surface of the toner seal member 10h opposing the developing opening 10b11 is constituted to the toner in order to prevent the toner from moving from the toner accommodating portion 10b1 to the developing portion 10b9. The developing opening surface 10b2 is constituted by an area (portion) from the one end of the toner seal member 10h to the folding-back portion 10h1. Here, the developing opening surface 10h2 corresponds to a coating surface at which the developing opening 10b11 is covered to suppress the movement of the toner contained in the toner accommodating portion 10b1 when the developing device 10 is not yet used.

The toner seal member 10h is pulled out while a back surface opposite from the developing opening surface 10h2 is contacted to a first corner portion 10f1 and a second corner portion 10f2 and while the developing opening surface 10h2 is contacted to the wiping projection 10g.

By the constitution as described above, in this embodiment, in addition to the effect obtained in Embodiment 1, the following effect can be achieved. That is, when the toner seal member 10h is pulled out (i.e., when the toner seal member 10h passes through the toner seal opening 10j), the wiping projection 10g provided on the magnetic seal 10i can remove the toner deposited on the developing opening surface 10h2 of the toner seal member 10h. Here, the wiping projection 10g is provided and extended over the entire leakage preventing surface 10i4 with respect to a direction perpendicular to the pulling-out direction of the toner seal member 10h. As a result, when the toner seal member 10h is pulled out, the wiping projection 10g can be contacted to the entire area of the developing opening surface 10h2, so that the toner deposited on the developing opening surface 10h2 can be removed with high reliability.

Therefore, even when there is no cap member or the like for confining the toner, it becomes possible to remove, when the toner seal member 10h is pulled out, the toner deposited on the developing opening surface 10h2.

Parts (a) and (b) of FIG. 10 are schematic views showing a form in which a plurality of projections 10g are provided on the leakage preventing surface 10i4 of the magnetic seal 10i, in which (a) of FIG. 10 is a perspective view and (b) of FIG. 10 is a sectional view. As shown in (a) and (b) of FIG. 10, it is possible to further reliably remove the toner by providing the plurality of projections 10g on the leakage preventing surface 10i4 of the magnetic seal 10i.

Incidentally, in this embodiment, the wiping projection 10g is provided on the leakage preventing surface 10i4 of the magnetic seal 10i but the present invention is not limited thereto. That is, the wiping projection 10g may be provided on at least either one of the leakage preventing surface 10i4 of the magnetic seal 10i and the opening forming portion 10b2 of the developing device frame 10b. The wiping projection 10g may more preferably be provided on a portion, of the leakage preventing surface 10i4 and the opening forming portion 10b2, where it opposes the developing opening surface 10h2 when the toner seal member 10h passes through the toner seal opening 10j. Further, in this embodiment, the opening forming portion 10b2 is provided with a wiping recess portion 10f is provided but the present invention is not limited thereto. That is, a constitution in which the wiping recess portion 10f is not provided at the opening forming portion 10b2 may also be employed.

### Embodiment 4

In this embodiment, constituents or portions similar to those in Embodiments 1 to 3 are represented by the same reference numerals or symbols, thus being omitted from the description.

In Embodiment 3, the wiping projection 10g was provided on the leakage preventing surface 10i4 of the magnetic seal 10i, and the wiping recess portion 10f was provided at the opening forming portion 10b2 of the developing device frame 10b. On the other hand, in this embodiment, the wiping projection 10g is provided on the opening forming portion 10b2 of the developing device frame 10b, and the wiping recess portion 10f is provided at the leakage preventing surface 10i4 of the magnetic seal 10i. Here, in this embodiment, for the sake of explanatory convenience, a projection (projected portion) provided on the opening forming portion 10b of the developing device frame 10b is referred to as the wiping projection 10g, and the recess portion (recessed portion) provided at the leakage preventing surface 10i4 of the magnetic seal 10i is referred to as the wiping recess portion 10f.

Part (a) of FIG. 11 is a sectional view showing a structure of the developing device 10 in this embodiment, and (b) of FIG. 11 is a schematic view of a cross section of the developing device 10 taken along a chain line B indicated in (a) of FIG. 11 and as seen from a direction indicated by an arrow X in (a) of FIG. 11.

At the opening forming portion 10b2 of the developing device frame 10b, a wiping projection 10g projected in a direction of the leakage preventing surface 10i4 of the magnetic seal 10i is provided. At the leakage preventing surface 10i4 of the magnetic seal 10i, a wiping recess portion 10f where the wiping projection 10g enters is provided. The wiping recess portion 10f is configured so that it is not contacted to the wiping projection 10g and is spaced from the leakage preventing surface 10i4 by a predetermined distance.

Part (a) of FIG. 12 is a schematic perspective view of the magnetic seal 10i in this embodiment. The recess portion 10f is extended over the entire leakage developing sleeve 10i4 with respect to a direction perpendicular to the pulling-out direction of the toner seal member 10h. Part (b) of FIG. 12 is a schematic perspective view of the developing device frame 10b. The wiping projection 10g is extended over the entire opening forming portion 10b2 with respect to the direction perpendicular to the pulling-out direction of the toner seal member 10h.

Part (a) of FIG. 13 is a schematic perspective view of the developing device frame 10b. The toner seal member 10h is a film-like sheet member. Further, the toner seal member 10h is provided on the developing device frame 10b by being slidably interposed between the developing device frame 10b and a toner seal fixing member 10b12 fixed to the developing device frame 10b by welding or the like. The end portion 10h3 of the toner seal member 10h passes through the toner seal opening 10j and is pulled out to the outside of the developing device 10. The developing opening surface 10h2 which is a surface of the toner seal member 10h where the toner seal member 10h opposes the developing opening 10b11, is contacted to the toner in order to confine the toner so as not to move from the toner accommodating portion 10b1 to the developing portion 10b9.

Part (b) of FIG. 13 is a schematic view showing a state in which the toner seal member 10h shown in (b) of FIG. 11 is pulled out in a pulling-out direction indicated by an arrow Y. The toner seal member 10h is pulled out while a back surface opposite from the developing opening surface 10h2 is contacted to a first corner portion 10f1 and a second corner portion 10f2 and while the developing opening surface 10h2 is contacted to the wiping projection 10g.

By the constitution as described above, similarly as in Embodiment 3, the wiping projection 10g provided on the developing device frame 10b can remove the toner deposited on the developing opening surface 10h2 of the toner seal member 10h. Therefore, even when there is no cap member or the like for confining the toner, it becomes possible to remove, when the toner seal member 10h is pulled out, the toner deposited on the developing opening surface 10h2.

### Embodiment 5

In this embodiment, constituents or portions similar to those in Embodiments 1 to 4 are represented by the same reference numerals or symbols, thus being omitted from the description.

Part (a) of FIG. 14 is a sectional view showing a structure of the magnetic seal 10i in this embodiment. The magnetic seal 10i includes a through slit 10i7.

Part (b) of FIG. 14 is a schematic sectional view of the developing device 10. In this embodiment, the through slit 10i7 is configured, as a portion corresponding to the toner seal opening 10j in the embodiments described above, so that the end portion 10h3 of the toner seal member 10h can pass through the through slit 10i7 and can be pulled out from the outside the developing device 10.

Part (c) of FIG. 14 is a schematic view showing a magnetic pole pattern of the magnetic seal 10i. The through slit 10i7 of the magnetic seal 10 is blocked with a magnetic brush of a chain of the toner formed along magnetic lines of force, so that the toner is prevented from flowing to the outside of the developing device 10.

By the constitution as described above, the toner leakage to the outside of the developing device 10 can be prevented by the magnetic force of the through slit 10i7, as the toner seal opening 10j, of the magnetic seal 10i, so that it is possible to obtain an effect similar to that in Embodiment 1 also in this embodiment.

As described above, by employing the constitution in Embodiments 1 to 5, it is possible to constitute the toner seal opening 10j which can be easily assembled on the developing device 10 and permits a small pulling-out force of the toner seal member 10h without impairing the toner seal function and without increasing the number of parts.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 097113/2010 filed Apr. 20, 2010, which is hereby incorporated by reference.

What is claimed is:

1. A developing device comprising:
a developer carrying member for carrying a magnetic developer to form a developer image on an image bearing member;
a developing device frame including a first accommodating chamber for accommodating the magnetic developer and including a second accommodating chamber, in which said developer carrying member is provided, for accommodating the magnetic developer supplied from said first accommodating chamber through a first opening;
a removable sealing member for sealing the first opening; and
a magnetic seal, provided between a longitudinal end portion of said developer carrying member and said developing device frame, wherein said sealing member is removable through a second opening which is defined at least partly by said magnetic seal.

2. A device according to claim 1, wherein the second opening is provided with a projection for removing the magnetic developer deposited on said sealing member when said sealing member passes through the second opening.

3. A device according to claim 2, wherein the second opening is provided with a recess portion, and the projection enters the recess portion.

4. A developing device comprising:
a developer carrying member for carrying a magnetic developer to form a developer image on an image bearing member;
a developing device frame including a first accommodating chamber for accommodating the magnetic developer and including a second accommodating chamber, in which said developer carrying member is provided, for accommodating the magnetic developer supplied from said first accommodating chamber through a first opening;
a removable sealing member for sealing the first opening, wherein said sealing member is removable through a second opening; and
a magnetic seal, provided between a longitudinal end portion of said developer carrying member and said developing device frame, for preventing the magnetic developer from moving to an outside of said developing device through the second opening.

5. A device according to claim 4, wherein the second opening is provided with a projection for removing the magnetic developer deposited on said sealing member when said sealing member passes through the second opening.

6. A device according to claim 5, wherein the second opening is provided with a recess portion, and the projection enters the recess portion.
